(19) United States
(12) Patent Application Publication
(10) Pub. No.: US 2015/0245351 A1
(43) Pub. Date: Aug. 27, 2015

(54) COMMUNICATING DATA OVER A MESH NETWORK

(71) Applicant: Cambridge Silicon Radio Limited, Cambridge (GB)

(72) Inventors: Raja Banerjea, San Jose, CA (US); Robin Heydon, Cottenham (GB)

(73) Assignee: Cambridge Silicon Radio Limited, Cambridge (GB)

(21) Appl. No.: 14/450,035

(22) Filed: Aug. 1, 2014

(30) Foreign Application Priority Data
Feb. 25, 2014 (GB) 1403314.6
Mar. 31, 2014 (GB) 1405797.0

(51) Int. Cl. H04W 72/04; H04L 29/06; H04W 4/00; H04W 84/12

(52) U.S. Cl. CPC H04W 72/0446; H04W 84/12; H04L 69/22; H04W 4/008

(57) ABSTRACT

A wireless communications device capable of operating according to a WLAN communications protocol, and capable of communicating in a mesh network. The wireless communications device may be configured to generate a mesh network data packet. The device may encapsulate the mesh network data packet in a WLAN data frame. The data frame may be constructed such that it is capable of being received and accurately decoded by WLAN-capable devices with which the wireless communications device has not established a WLAN communications connection. The device may then transmit the WLAN data frame.

### TECHNICAL FIELD

This invention relates to a communications device that is capable of sending and receiving data packets over a mesh network.

### BACKGROUND

There is an increasing need for a variety of objects to be equipped with the ability to send and receive messages. In the case of the home, for example, it may be desirable for multiple devices to be able to communicate with each other, and also potentially with the internet or cloud, in order to allow for more automated control of the home. For example, a home may contain a lighting system, heating appliances and sensor devices. By allowing these devices to communicate with each other certain controls can be automated, such as turning on the lights and the heating when the sensor detects that a person has entered a room.

To enable arbitrary objects to communicate, they can be equipped with communication devices. As many of these objects may not have access to, or require, power themselves (for example a window or a door), there may be a desire that the communication devices be battery-powered devices that consume very little power.

Low-powered communications equipment may not have sufficient communication range to communicate directly with other equipment located in the network. A suitable network for such devices to adopt may be a mesh network, in which a device can communicate with a remote device outside its communication range via one or more intermediary devices. In this arrangement the intermediary devices may function to relay a received message.

FIG. 1 shows such a mesh network. The network may comprise a number of devices 101, 102, 103 and 104. Device 101 may include switch 101b, device 102 may include light fitting 102b, and device 104 may include light fitting 104b. Each device can communicate wirelessly with other devices that are in effective range of it by means of an incorporated wireless communications device 101a, 102a, 103 and 104a. The communications devices may cooperate to propagate signals between them. The communication range of device 101a may be bounded by boundary 105. The communication range of device 103 may be bounded by boundary 106. If communications device 101a transmits a signal, that signal can be received by devices 102a and 103, which are within range of device 101a. Device 104a is out of range of device 101a. However, device 103 can relay the signal received from device 101a so that it can be received by device 104a. This method of communication can allow devices to communicate even though they are out of direct range of each other.

Several different wireless communications protocols have been proposed to communicate between devices in a mesh network. Generally speaking, the greater the communications range of the communications protocol, the more power the device consumes in communicating using that communications protocol. WLAN (Wireless Local Area Network) communications protocols have a relatively large communications range, which may be beneficial for increasing the connected range of objects in a mesh network, for example in the home. Further the value of a network according to Metcalfe's law is proportional to the square of the number of connected devices. By increasing the number of connected devices in a network with mesh the value of the network may increase dramatically.

IEEE 802.11s is a WLAN communications protocol, which supports mesh networking. Communications may be routed through a mesh network from a source node to a sink node via relay nodes. 802.11s typically requires a route discovery protocol to be used. Thus, each node in the mesh network discovers its neighbouring nodes and authenticate with them in order to establish communication routing paths to those neighbouring nodes. Having implemented the route discovery protocol to establish routing paths to its neighbouring nodes, a node may then relay mesh packets received from another node to its neighbouring nodes on the routing paths. This routing procedure utilizes processing power and memory to implement, thus potentially increasing the power consumption of the devices in the mesh network relative to ones which do not route data.

Wi-Fi Sensor Net is another Wi-Fi communications protocol. Wi-Fi Sensor Net supports bridging of communications between devices connected together in an infrastructure network and devices connected together in a point-to-point manner. Thus, communications may be routed from a source node to a sink node via one or more relay nodes. However, devices undergo connection establishment with each other before they are able to route communications between each other. The connection establishment procedure may utilize processing power and memory to implement, thus potentially increasing the power consumption of those devices relative to ones which do not route data.

Thus, there may be a desire for an improved way of relaying data packets in a mesh network that maintains a large connected range, but has lower power and memory requirements than the approaches described above.

### SUMMARY OF THE INVENTION

According to one aspect of the invention, there is provided a wireless communications device capable of operating according to a WLAN communications protocol, and capable of communicating in a mesh network, the wireless communications device being configured to: generate a mesh network data packet; encapsulate the mesh network data packet in a WLAN data frame, wherein the WLAN data frame is constructed such that it is capable of being received and accurately decoded by WLAN-capable devices with which the wireless communications device has not established a WLAN communications connection; and transmit the WLAN data frame.

Suitably, the WLAN data frame is a WLAN beacon frame.

Suitably, the wireless communications device is capable of operating according to a second wireless communications protocol different to the WLAN communications protocol, and the wireless communications device is further configured to: receive a prior mesh network data packet according to the second wireless communications protocol, the prior mesh network data packet comprising a payload; and generate the mesh network data packet such that the payload of the mesh network data packet comprises the payload of the prior mesh network data packet.

Suitably, the second wireless communications protocol is a Bluetooth Low Energy protocol.

Suitably, the prior mesh network data packet comprises a first lifetime value, and the wireless communications device is further configured to only generate the mesh network data packet such that the payload of the mesh network data packet comprises the payload of the prior mesh network data packet if the first lifetime value is indicative that the payload of the prior mesh network data packet is to be relayed to other devices.

Suitably, the mesh network data packet comprises a second lifetime value, and the wireless communications device is further configured to select the second lifetime value so as to indicate that the payload of the prior mesh network data packet has been received and relayed.

Suitably, the wireless communications device is further configured to: perform a comparison of a portion of the prior mesh network data packet and a record of mesh network data packets previously received by the wireless communications device; and only generate the mesh network data packet such that the payload of the mesh network data packet comprises the payload of the prior mesh network data packet if the comparison indicates that the prior mesh network data packet has not been previously received by the wireless communications device.

According to a second aspect of the invention, there is provided a wireless communications device capable of operating according to both a first wireless communications protocol and a second wireless communications protocol, and capable of communicating in a mesh network, the wireless communications device being configured to: receive a prior mesh network data packet according to the second wireless communications protocol, the prior mesh network data packet comprising a payload; generate a mesh network data packet such that the payload of the mesh network data packet comprises the payload of the prior mesh network data packet; encapsulate the mesh network data packet in a data frame according to the first wireless communications protocol; and transmit the data frame.

Suitably, the first wireless communications protocol is a WLAN protocol.

Suitably, the wireless communications device is further configured to construct the data frame such that it is capable of being received and accurately decoded by WLAN-capable devices with which the wireless communications device has not established a WLAN communications connection.

Suitably, the data frame is a WLAN beacon frame.

Suitably, the second wireless communications protocol is a Bluetooth Low Energy protocol.

Suitably, the wireless communications device is further configured to construct the data frame such that it is capable of being received and accurately decoded by devices capable of operating according to the first wireless communications protocol with which the wireless communications device has not established a communications connection according to the first wireless communications protocol.

Suitably, the prior mesh network data packet comprises a first lifetime value, and the wireless communications device is further configured to only generate the mesh network data packet such that the payload of the mesh network data packet comprises the payload of the prior mesh network data packet if the first lifetime value is indicative that the payload of the mesh network data packet is to be relayed to other devices.

Suitably, the mesh network data packet comprises a second lifetime value, and the wireless communications device is further configured to select the second lifetime value so as to indicate that the payload of the prior mesh network data packet has been received and relayed.

Suitably, the wireless communications device is further configured to: perform a comparison of a portion of the prior mesh network data packet and a record of mesh network data packets previously received by the wireless communications device; and only generate the mesh network data packet such that the payload of the mesh network data packet comprises the payload of the prior mesh network data packet if the comparison indicates that the prior mesh network data packet has not been previously received by the wireless communications device.

According to a third aspect of the invention, there is provided a wireless communications device capable of operating according to a WLAN communications protocol, and capable of communicating in a mesh network, the wireless communications device being configured to: receive a WLAN data frame from a WLAN-capable device with which the wireless communications device has not established a WLAN communications connection; extract from the WLAN data frame a mesh network data packet, the mesh network data packet having been encapsulated in the WLAN data frame; and accurately decode the mesh network data packet.

Suitably, the WLAN data frame is a WLAN beacon frame.

Suitably, the mesh network data packet comprises a payload and a first lifetime value, and wherein the wireless communications device is further configured to: generate a further mesh network data packet such that the payload of the further mesh network data packet comprises the payload of the mesh network data packet only if the first lifetime value is indicative that the payload is to be relayed to other devices; and transmit the mesh network data packet.

Suitably, the further mesh network data packet comprises a second lifetime value, and the wireless communications device is further configured to select the second lifetime value so as to indicate that the payload of the mesh network data packet has been received and relayed.

### BRIEF DESCRIPTION OF THE DRAWINGS

The present invention will now be described by way of example with reference to the drawings. In the drawings:

FIG. 1 illustrates a mesh network;

FIG. 2 illustrates a wireless communications device;

FIG. 3 illustrates a protocol stack of a mesh architecture;

FIG. 4 illustrates a packet format of the transport protocol within the network;

FIG. 5 illustrates a protocol stack of a connected WLAN device;

FIG. 6 illustrates a protocol stack of an unconnected WLAN device;

FIG. 7 illustrates the format of a WLAN beacon frame;

FIG. 8 illustrates an example connection topology using BLE and WLAN in a connected mode; and

FIG. 9 illustrates an example connection topology using BLE and WLAN in an unconnected mode.

### DETAILED DESCRIPTION

The following description is presented to enable any person skilled in the art to make and use the invention, and is provided in the context of a particular application. Various modifications to the disclosed embodiments will be readily apparent to those skilled in the art.

The general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The following describes a mesh network in which data is transmitted between wireless communication devices. That data is described herein as being transmitted in packets and/or frames and/or messages. This terminology is used for convenience and ease of description. Packets, frames and messages have different formats in different communications protocols. Some communications protocols use different terminology. Thus, it will be understood that the terms “packet” and “frame” and “messages” are used herein to denote any signal, data or message transmitted over the network.

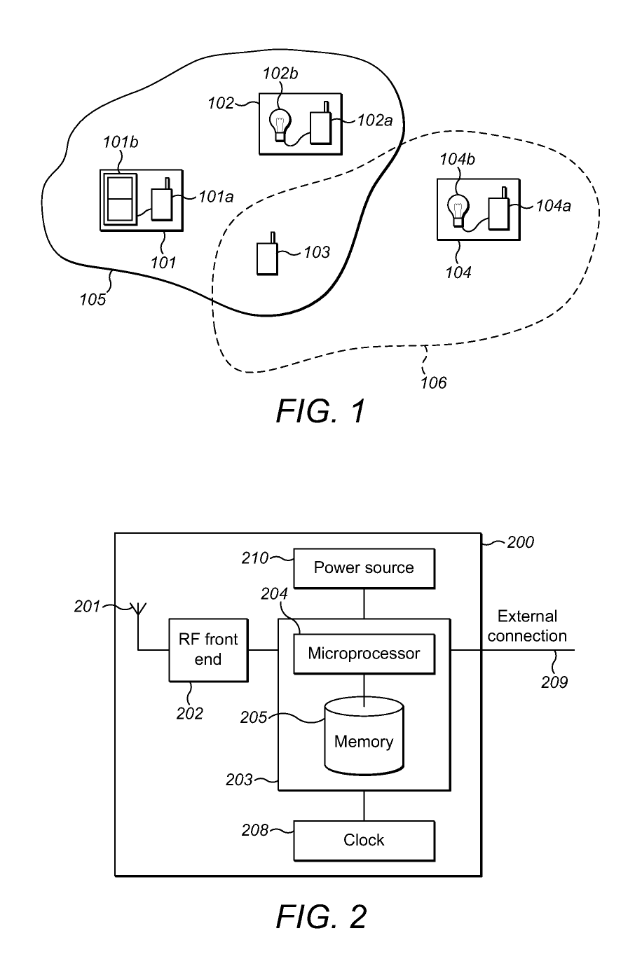

FIG. 2 shows the architecture of a wireless communications device suitable for communicating data over a mesh network such as that described with reference to FIG. 1. The device 200 comprises an antenna 201, a radio frequency (RF) front end 202 and a baseband processor 203. The baseband processor 203 comprises a microprocessor 204 and a non-volatile memory 205. The non-volatile memory 205 stores in non-transitory form program code that is executable by the microprocessor to cause the baseband processor to implement the communications protocol of the network and the methods described herein.

In order to transmit signals into the mesh network, the processor 203 can drive the RF front end 202, which in turn causes the antenna 201 to emit suitable RF signals. Signals received at the antenna 201 from the mesh network can be pre-processed (e.g. by analogue filtering and amplification) by the RF front end 202, which presents corresponding signals to the processor 203 for decoding. The processor can respond to those signals in various ways, as will be described in more detail below.

The device also comprises a clock 208, which can be turned on or off by the microprocessor 204 in order to save power, and optionally an external connection 209 suitable for exchanging information with the device's associated appliance if it has one. Suitably, this external connection 209 is wired. This information may include sensing external events (e.g. the operation of an associated user interface device such as a switch) or issuing control signals to associated appliances (e.g. to turn a light bulb on or off). The device also comprises a power source 210, which may be a battery. The device may also be mains-powered.

The RF front end 202 and the baseband processor 203 could be implemented on one or more integrated circuits.

In the case that the wireless communications device operates according to two or more communications protocols, it may have separate transceiver circuitry for each communications protocol, in which case the device of FIG. 2 would additionally have a further antenna, RF front end and baseband processor for each communications protocol that it supports. Alternatively, one or more of the antenna, RF front end and baseband processor may be shared by two or more of the communications protocols that the device is configured to communicate with.

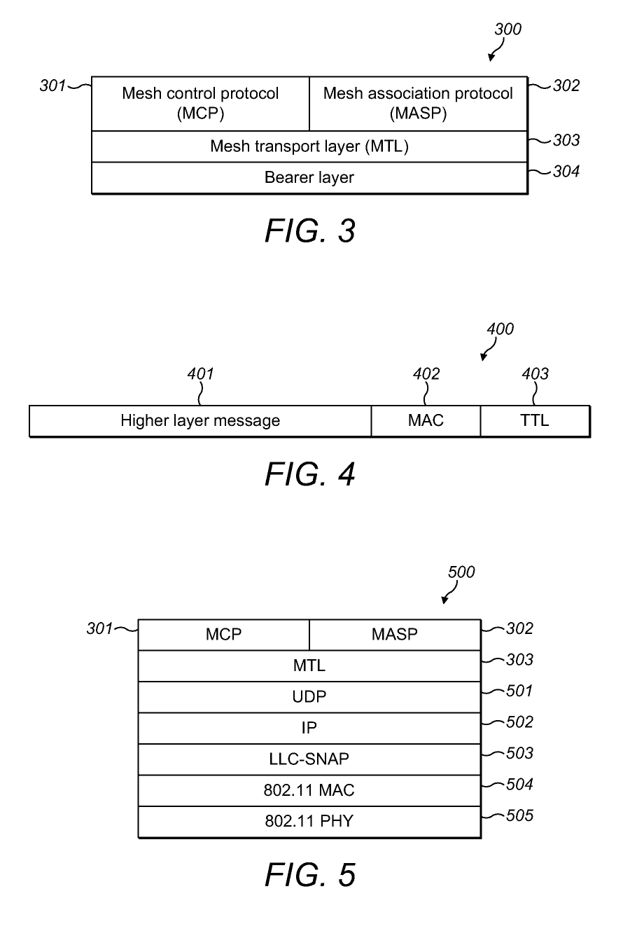

Suitably, the mesh network operates by communicating data packets among devices in the network. Those data packets may be determined in accordance with the architecture stack 300 illustrated in FIG. 3.

The Mesh Association Protocol (MASP) 302 is used by a device to transmit messages into and receive messages from the Mesh Transport Layer (MTL) 303 for the purpose of enabling new devices to be configured to be part of the mesh network. A device authenticates and distributes one or more network keys to a new device in accordance with the MASP. Following this association process, the new device receives a device identifier which it can use to communicate with other devices in the mesh network according to the Mesh Control Protocol. Thus, the new device can receive messages addressed to it to cause it to perform an action, such as to change its configuration.

The Mesh Control Protocol (MCP) 301 is used to transmit messages into the Mesh Transport Layer (MTL) 303 for the purpose of control and monitoring applications. The MCP uses the device identifiers, distributed during association, to identify the sender of a message and the individual or group recipient of the message. The intended recipient or recipients of the message may then perform an action in response to receiving the message, that action being defined in the message. For example, the message may address all light fittings in the mesh network and instruct them to turn off. In response to receiving this message, the light fittings implement the instruction and turn off. As another example, the message may address one or more recipients and instruct them to report their current state. In response to receiving this message, those recipients send a response back to the identified sender of the message reporting their current state.

The messages generated in accordance with the MCP layer may be reliable or unreliable. Reliable messages are messages which the MCP layer determines have been received by the receiver. This may be implemented by the MCP including a transaction ID in the message to be transmitted by the bearer layer 304. The recipient of the message acknowledges receipt of the message, and includes the transaction ID in the acknowledgement message. Thus, on receiving the acknowledgement message, the MCP matches the transaction ID in the acknowledgement message to the transaction ID of the transmitted message, and thus determines that that transmitted message was reliably received. Unreliable messages are messages which the MCP layer is unable to determine have been received by the receiver.

For example, this may be implemented by the MCP not including a transaction ID in the message to be transmitted by the bearer layer. Typically, these unreliable messages are used for status messages and/or for user-initiated actions that may be repeated again quickly, for example rotating a dimmer control for a light.

The Mesh Transport Layer (MTL) 303 enables the transmission and reception of mesh messages. The MTL generates mesh transport packets of the format shown in FIG. 4. The mesh transport packet 400 comprises a higher layer message field 401, a Message Authentication Code (MAC) field 402 and a lifetime or Time-To-Live (TTL) field 403. The MAC is computed based on the contents of the higher layer message field 401.

The payload of the mesh transport packet 400 can be defined as the higher layer message field 401 and the MAC field 402. The payload of the mesh transport packet 400 can also be described as the static content of the mesh transport packet 400 because it is not altered as it is retransmitted throughout the mesh network. The higher layer message field 401 may comprise the identifier of the sender and a serial number. The serial number can be unique to that particular sender. The pair of the sender identifier and the serial number is a transaction identifier which uniquely identifies a particular message within the mesh network.

Suitably, when a device receives the mesh transport packet 400, it is configured to process parts of it to decide whether to retransmit it or not. Retransmitting the packet enables it to be received by more devices within the mesh network. However, retransmission of a packet can also cause congestion within the network. Also, the message and/or data within the packet may have an expiry period and so after this period propagation throughout the network is no longer required. Hence, the device is configured to process parts of the mesh transport packet 400 to decide whether to retransmit it.

The receiving device may determine whether the payload of the mesh transport packet 400 has previously been received by that particular receiving device. If the payload of the mesh transport packet 400 has previously been received by the communication device, then the communication device does not retransmit the packet. If the payload of the mesh transport packet 400 has not previously been received by the communication device, then the communication device decides whether to retransmit the packet based on the lifetime field 403 as described below.

The determination as to whether the payload has previously been received may be implemented by the communication device being configured so that it stores a record of the static content of the mesh transport packet 400. The communication device may be configured to record only a part of the static content of the mesh transport packet 400 or a representation of it. This record can then be compared against a received packet to decide whether to retransmit it. The communication device may be configured to store the record in memory 205.

The record of the static content of the mesh transport packet 400 may comprise:
a record of the whole payload. The payload may comprise the higher layer message field 401 and the MAC field 402. Alternatively, the payload may be the static content of the mesh transport packet 400. The static content of the mesh transport packet 400 may not include the lifetime field 403 which can be changed each time the packet is sent.
a record of the MAC. The MAC is probabilistically likely to be a unique identifier for the payload as a whole.
The transaction identifier contained within the higher layer message field 401.
Any portion of the static content of the mesh transport packet 400 that is unique to the static content of that particular mesh transport packet 400.

As storage within the communication device 200 may be limited, the record of the static content may be limited in size. Once full the communication device 200 may be configured to overwrite the oldest entry in the record. The communication device 200 may store the record of the static content in a table.

The Time-To-Live field 403 can more generally be a lifetime field 403 that defines the lifetime of the mesh transport packet 400 within the mesh network. The lifetime field 403 of the mesh transport packet 400 is used by the receiving device to determine whether the received mesh transport packet 400 should be retransmitted.

If the lifetime field 403 is equal to a threshold value then the packet is not retransmitted. If the lifetime field 403 is not equal to a threshold value then the packet is retransmitted. If the packet is retransmitted then the higher layer message field 401 and the MAC field 402 are unaltered in the retransmission packet from the received packet. The lifetime field is altered by the retransmitting device to indicate that it has been retransmitted. The lifetime field may contain an integer number that is decremented by the retransmitting device to indicate that it has been retransmitted. The lifetime field may be decremented by one. If the content of the lifetime field is decremented upon retransmission then the stored threshold value will be set equal to or less than the initial value of the lifetime field 403 as set by the original sending device.

An example of how the lifetime field 403 may be used by the receiving device to determine whether the received mesh transport packet 400 should be retransmitted will now be described. In this example, if the lifetime field 403 is equal to a threshold value then the packet is not retransmitted. If the lifetime field 403 is not equal to a threshold value then the packet is retransmitted. If the packet is retransmitted then the higher layer message field 401 and the MAC field 402 are unaltered in the retransmission packet from the received packet. The lifetime field is altered by the retransmitting device to indicate that it has been retransmitted.

In the example, the original sending device sets the lifetime field 403 to a value that is greater than zero. In this case, the lifetime field 403 is also known as a TTL field 403. If the receiving device receives a mesh transport packet 400 with a TTL value that is greater than zero, the receiving device sets the TTL value to one less than the value of the field in the received message and retransmits the packet. If the receiving device receives a mesh transport packet 400 with a TTL value that is equal to zero the receiving device does not retransmit the packet. In this case, the threshold value may be zero. This implementation has the advantage that no configuration is required to vary thresholds at the receiving devices. For example, if a message has a relatively high priority, so that it is desired for it to be retransmitted a higher number of times than a lower priority message, the TTL value can be set to a higher value initially by the original sending device than the TTL value in a lower priority message.

In the above described configuration, the behaviour of a device upon reception of a mesh transport packet 400 forms the transport layer of the network. The individual devices do not need to process the data contained within the higher layer message 401 to decide whether to retransmit messages within the network and so provide delivery of messages beyond the distance enabled by an individual device.

Returning to FIG. 3, the bearer layer 304 defines how mesh messages are transported between devices over one or more bearers. Several different bearer layers may be supported which cause mesh messages to be transported according to different wireless communications protocols. For example, as described in more detail later, a wireless communications device may support one, two or all of the following bearers (or others not listed):
Bluetooth Low Energy Advertising
Bluetooth Low Energy GATT Mesh Service
IEEE 802.11

In the following example, the wireless communications device 200 uses a WLAN protocol to transport the mesh network data packets. For example, the wireless communications device 200 may use a Wi-Fi protocol. As used herein, a Wi-Fi product is any wireless local area network (WLAN) product that is based on the Institute of Electrical and Electronics Engineers' (IEEE) 802.11 standards, and a Wi-Fi protocol is any IEEE 802.11 protocol. In this example, the wireless communications device first generates a mesh network data packet as described with reference to FIG. 4 and having the same format as the packet in FIG. 4.

The device then encapsulates the generated mesh network data packet within a WLAN data frame. Suitably, the mesh network data packet forms part of the payload of the WLAN data frame. The device then transmits the WLAN data frame according to the WLAN protocol.

In a first implementation, the device is in a connected mode. In other words, the device is connected to one or more other devices in the mesh network via a WLAN communications link. In this case, the device suitably communicates data packets in accordance with the protocol stack 500 illustrated in FIG. 5. The User Datagram Protocol (UDP) layer 501, IP layer 502, LLC-SNAP layer 503, 802.11 MAC layer 504 and 802.11 PHY layer cumulatively act as the bearer layer 304 of FIG. 3. The mesh network data packet 400 generated at the

MTL layer 303 is encapsulated in the payloads of the lower layer WLAN messages. One or more header of the lower layer WLAN messages addresses the resulting WLAN frame to one or more devices of the mesh network to which the transmitting device is connected. The device then transmits the WLAN frame.

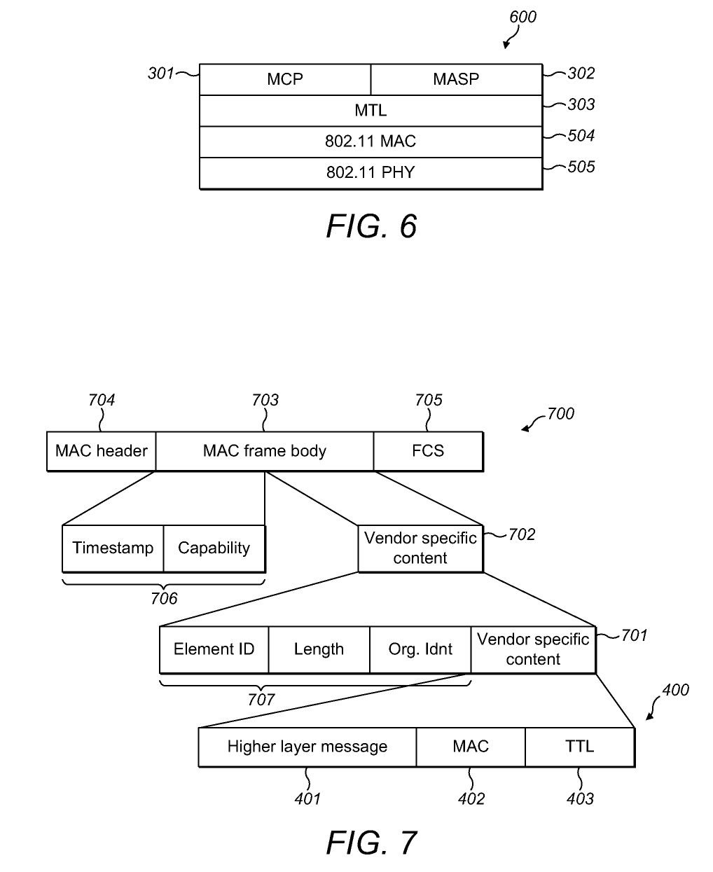

In an alternative implementation, the device is in an unconnected mode. In other words, the device is not connected to other devices in the mesh network via a WLAN communications link. In this case, the device suitably communicates data packets in accordance with the protocol stack 600 illustrated in FIG. 6. The 802.11 MAC layer 504 and 802.11 PHY layer cumulatively act as the bearer layer 304 of FIG. 3. The mesh network data packet 400 generated at the MTL layer 303 is encapsulated in the payloads of the lower layer WLAN messages and the resulting WLAN frame transmitted. The WLAN frame is not specifically addressed to particular WLAN-enabled devices of the mesh network. The WLAN frame is constructed such that it is capable of being received and accurately decoded by WLAN-capable devices which are not connected to the transmitting device. For example, the WLAN frame may be a WLAN beacon frame. Suitably, the WLAN beacon frame is broadcast from the transmitting device. WLAN beacon frames are typically management frames which are transmitted periodically to announce the presence of the WLAN device.

FIG. 7 illustrates an exemplary format of a WLAN beacon frame 700. The mesh network data packet 400 comprises the same format as shown in FIG. 4. This mesh network data packet is encapsulated within the vendor specific content 701, 702 of the MAC Frame Body 703 of the beacon frame 700. In other words, the mesh network data packet is included in the payload of the WLAN beacon frame 700.

WLAN-enabled devices of the mesh network periodically scan for WLAN beacon frames. On receiving a WLAN beacon frame, a WLAN-enabled device of the mesh network processes the WLAN beacon frame by passing it up its protocol stack which is the same as that shown on FIG. 6. As the message is passed up the stack, the portions of the message relevant to the lower layers of the stack are removed. Thus, the MAC header 704, Frame Check Sequence 705, headers 706 (e.g., a timestamp and capability) and headers 707 (e.g., an element ID, length, and originating identity) shown on FIG. 7 are all removed by the lower layers leaving the mesh network data packet 400 to enter the MTL layer. The MTL, MCP and MASP layers decode and act on the instructions of the mesh network data packet as described above.

Similarly, in the case that a WLAN-ena bled device of the mesh network receives a WLAN data frame from a device to which it is connected, that WLAN data frame is passed up its protocol stack which is the same as that shown on FIG. 5. As the message is passed up the stack, the portions of the message relevant to the lower layers of the stack are removed, leaving the mesh network data packet 400 to enter the MTL layer. The MTL, MCP and MASP layers decode and act on the instructions of the mesh network data packet as described above.

In either the case that the WLAN-ena bled device of the mesh network receives a dedicated WLAN data frame that encapsulates a mesh network data packet or a WLAN beacon frame that encapsulates a mesh network data packet, it may respond to that mesh network data packet as discussed above. Specifically, the device may respond by retransmitting the payload of the mesh transport packet 400 only if the device determines that it has not previously received that payload in another mesh network data packet, in accordance with the methods discussed above. Similarly, the device may respond by retransmitting the payload of the mesh network data packet only if the lifetime value or TTL of the received mesh network data packet is indicative that the payload is to be relayed to other devices, in accordance with the methods discussed above. Suitably, the device responds by retransmitting the payload of the mesh network data packet only if both (i) the device determines that it has not previously received that payload in another mesh network data packet, in accordance with the methods discussed above, and (ii) the lifetime value or TTL of the received mesh network data packet is indicative that the payload is to be relayed to other devices, in accordance with the methods discussed above. If the device determines to retransmit the payload of the received mesh network data packet, it suitably generates a mesh network data packet which includes the payload of the received mesh network data packet and a lifetime value, or TTL value, which differs from the lifetime value or TTL value of the received mesh network data packet by a value which indicates that the payload of the received mesh network data packet has been received and relayed. For example, the lifetime value or TTL value of the mesh network data packet may be related to the lifetime value or TTL value of the received mesh network data packet by the relationship described earlier herein.

The WLAN-enabled device may retransmit the mesh network data packet using WLAN. Alternatively, the WLAN-enabled device may retransmit the mesh network data packet using another wireless communications protocol by encapsulating the mesh network data packet in a transmission frame of that other wireless communications protocol. Examples of other wireless communications protocols which may be used are Bluetooth Low Energy (marketed as Bluetooth SMART), Zigbee and Zwave.

By utilising a WLAN beacon frame (or other data frame which WLAN-enabled devices of the mesh network can receive and accurately decode even if they have not established a WLAN communications connection with the device that transmitted the WLAN frame) to transmit mesh network data messages, those mesh network data messages are relayed through the mesh network using lower power and memory than in IEEE 802.11s and Wi-Fi Sensor Net. This is because the mesh network data messages are able to be routed through a series of WLAN devices without those WLAN devices having to have first establish connections between themselves. Similarly, the mesh network data messages are able to be routed through a series of WLAN devices without implementing a route discovery mechanism. Thus, the processing power and memory required to establish the communications connections and/or implement the route discovery is not needed. Additionally, WLAN devices can participate in the mesh network without having to be associated with another device through the use of WSP (wireless session protocol) or a similar security algorithm. This allows for less error prone configuration of devices. Additionally, the messages can be routed more quickly through the mesh network because (i) there is no need to wait for devices to discover each other and connect with each other, and (ii) there is a greater density of devices available to retransmit the messages since both connected and unconnected devices can retransmit the messages rather than just connected devices. Additionally, the messages can be routed with lower complexity compared to the case where devices are connecting together a point-to-point network and an infrastructure network. This is because no additional protocol layers are required in the protocol stack to handle the routing of the messages between the mesh devices.

The wireless communications device 200 may use two or more wireless communications protocols to transport mesh network data packets. In the following example, the wireless communications device 200 is configured to operate according to a WLAN protocol and also the Bluetooth Low Energy (BLE) protocol. Bluetooth Low Energy communicates in the mesh network using the same protocol stack as shown in FIG. 3. In this case, the bearer layer 304 is implemented using Bluetooth Low Energy Advertising packets to transport the mesh network data packets. These mesh network data packets have the format shown in FIG. 4.

In this example, the wireless communications device 200 receives a first mesh network data packet according to the BLE protocol. For example, it may receive the first mesh network data packet encapsulated in a BLE advertising packet. The device passes the received BLE advertising packet up the protocol stack shown in FIG. 3 for processing. The first mesh network data packet comprises a first payload and a first lifetime value. The device determines to retransmit the first payload, for example after analysing the first mesh network data packet as described above to determine if the first payload has been previously received by the device and/or if the first lifetime value indicates that the first payload is to be relayed through the mesh network. Having determined to retransmit the first payload, the device generates a second mesh network data packet having the first payload. Suitably, the second mesh network data packet has a second lifetime value different to the first lifetime value, for example as described above. The device then encapsulates the second mesh network data packet into a WLAN data frame. The WLAN data frame is suitably constructed such that it is capable of being received and accurately decoded by WLAN-enabled devices with which the device has not established a WLAN communications connection, for example a WLAN beacon frame. The device then transmits the WLAN data frame. In the case of the WLAN beacon frame, the device broadcasts the WLAN beacon frame.

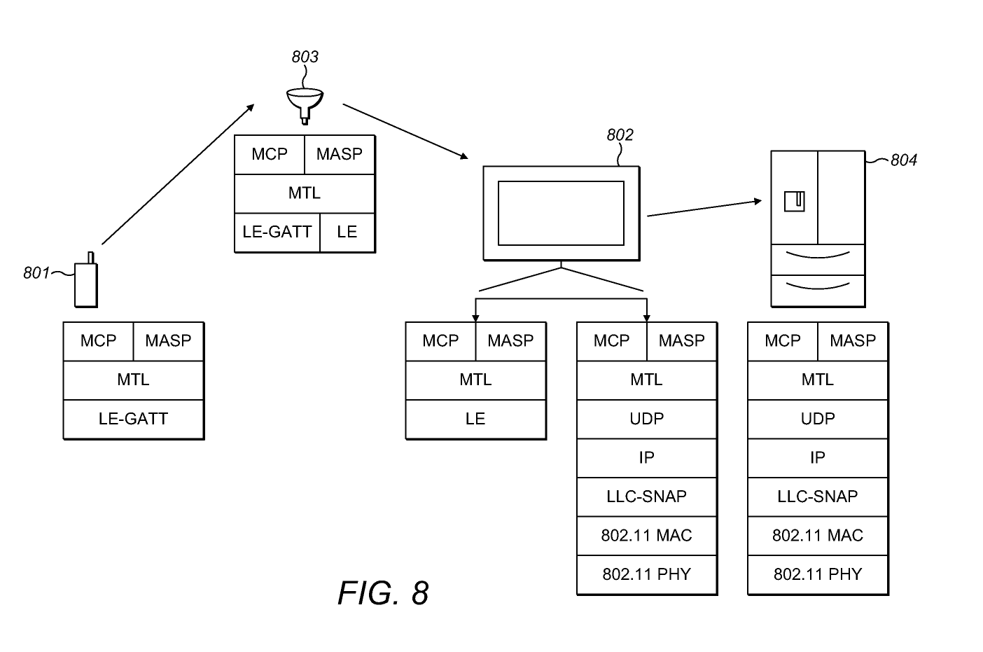

FIG. 8 illustrates an example mesh network connection topology in the home. A mesh packet is routed from a mobile phone 801 to an interactive television 802 via a light fitting 803. In the example shown, this routing is performed using BLE, specifically the BLE GATT Mesh Service. The mobile phone 801 routes a mesh packet to the light fitting 803 using MTL over LE-GATT. The light fitting 803 then routes the mesh packet to the television 802 using BLE advertising. The television 802 receives the mesh packet over its BLE interface. It then bridges the mesh packet to its WLAN interface, as described above, by extracting the mesh packet from the BLE packet and encapsulating the payload of the mesh packet into a WLAN data frame. The WLAN data frame is then routed to the refrigerator 804 using MTL over UDP. In FIG. 8, the television 802 has a WLAN connection established with the refrigerator 804. For example, the television 802 may be connected to the refrigerator 804 through an access point. FIG. 8 illustrates the case in which the television 802 is connected to the refrigerator 804 directly using WLAN Direct. The mesh packet is transported over the UDP interface.

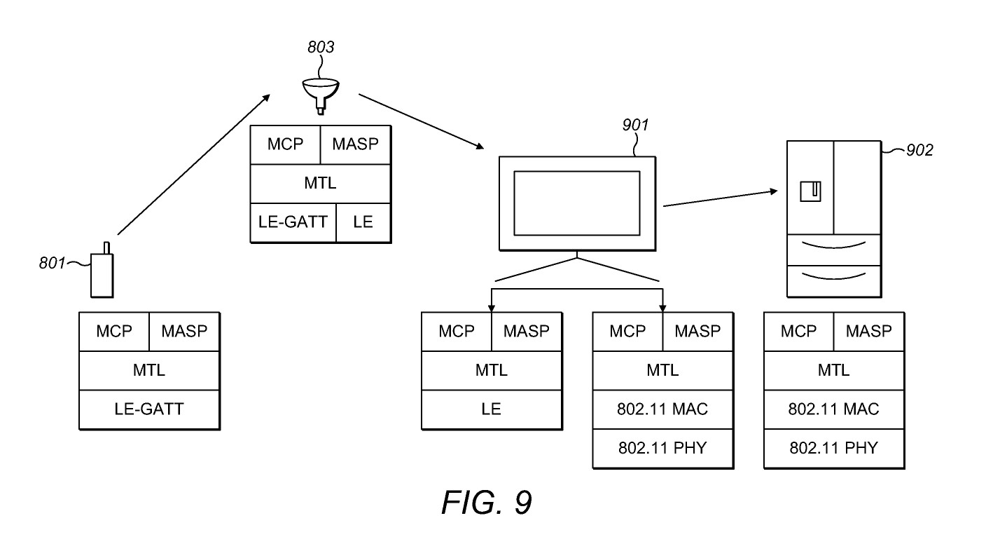

FIG. 9 illustrates a similar mesh network connection topology to FIG. 8. However, this time, there is no established WLAN connection between the television 901 and the refrigerator 902. As with the example shown in FIG. 8, a mesh packet is routed from the mobile phone 801 to the television 901 via the light fitting 803. This routing is performed using BLE, specifically the BLE GATT Mesh Service. The mobile phone 801 routes a mesh packet to the light fitting 803 using MTL over LE-GATT. The light fitting 803 then routes the mesh packet to the television 901 using BLE advertising. The television 901 receives the mesh packet over its BLE interface. It then bridges the mesh packet to its WLAN interface, as described above, by extracting the mesh packet from the BLE packet and encapsulating the payload of the mesh packet into a WLAN data frame. The WLAN data frame is then routed to the refrigerator 902. This is done using a WLAN data frame which is constructed such that it is capable of being received and accurately decoded by WLAN-enabled devices which aren't connected to the device. For example, the WLAN data frame may be a WLAN beacon frame.

In both the examples of FIGS. 8 and 9, the device uses the same mesh protocol layers whether it is using WLAN as the bearer or BLE. In other words, the device uses the MCP, MASP and MTL layers regardless of whether it transports the mesh packet using WLAN or BLE. Thus, the interface to the application is common for either WLAN or BLE.

The above examples describe receiving a mesh packet according to a first protocol and retransmitting the payload of that mesh packet according to a second protocol. The payload of the mesh packet may be encapsulated into more than one message of the second protocol to be subsequently transmitted. Taking FIG. 9 as an example, the TV 901 may retransmit the mesh packet payload it received from the light fitting 803 in multiple WLAN beacon frames. Retransmitting the mesh packet payload multiple times increases the reliability of the transmission, i.e. increases the likelihood that the receiver will accurately receive the mesh packet payload.

With respect to FIG. 7, a single mesh packet payload has been described as being encapsulated into a single WLAN data frame to be routed on in the mesh network. However, there may be more than one mesh packet payload encapsulated into a single WLAN (or other protocol) data frame. In the case that a plurality of mesh packet payloads are encapsulated into a single WLAN (or other protocol) data frame, these would be incorporated into the vendor specific portion 701,702 of the WLAN (or other protocol) data frame.

The number of times the payload of a mesh packet is retransmitted, and the specific ones of the mesh packets whose payloads are retransmitted, depends on the lifetime values of the individual mesh packets, as described above. Retransmission of the mesh packet payloads by the WLAN devices further increases the robustness of the mesh network.

When a WLAN device receives a WLAN data frame that includes one or more mesh packet payloads, it decodes the mesh packet payload according to the mesh protocol, as described above. If the device is the intended receiver then it processes the mesh packet. If the device is not the intended receiver then it retransmits the mesh packet payload based on the mesh protocol.

The above examples describe first transmitting a mesh packet using BLE, and then bridging that mesh packet to WLAN for further routing. Of course, the mesh packet may alternatively first be transmitted using WLAN and then bridged to BLE for further routing.

Routing using BLE in a mesh network has very low power requirements, thus is useful for nodes in the mesh network that have very low power availability. BLE is sufficient for communication purposes in areas where there is a high density of BLE devices, for example in the living room of a house. However, because BLE has very low power requirements it also has a short range. Thus, transport of mesh messages through a mesh network solely consisting of BLE communications may be slow or unreliable in areas where the density of BLE devices is low, for example in a stairwell or large hall. WLAN on the other hand has a larger range than BLE, thus enables better connectivity than BLE in areas where there is a low density of devices. But, WLAN has much higher power requirements than BLE. Thus, the heterogeneous deployment of BLE and WLAN in the mesh network increases the range of the devices connected in the mesh network without increasing the power usage to that required by a solely WLAN-connected network. This is because a device can route mesh messages using BLE where the BLE connectivity is sufficient, and using WLAN where needed to increase the connected range of the device.

Neither the described BLE or WLAN protocols described herein require the mesh devices to be connected, or to employ discovery protocols, or to schedule routing, thus relaying data between mesh devices is simpler and quicker than the data relaying in the IEEE 802.11s and Wi-Fi SensorNet networks.

As mentioned above, a common mesh protocol is described herein for both BLE and WLAN, which enables application developers to use a common application programming interface (API) irrespective of the transport protocol.

Although the above describes the wireless communications device 200 using BLE and WLAN, other combinations of two or more wireless communications protocols may be used. Suitably, the mesh network uses a lower power, shorter range protocol where that provides sufficient communications coverage, but utilises the longer range, higher power protocol in order to effectively increase the range of the mesh devices in the mesh network. This characteristic permits the devices to use less power for transmitting and/or receiving than would be expected in a longer range protocol. Examples of other short range wireless protocols are Zigbee and Zwave.

Suitably, whichever wireless communications protocols are used, the devices in the mesh network communicate in an ad hoc manner in order to transfer data between each other.

The structure shown in FIG. 2 is intended to correspond to a number of functional blocks in an apparatus. This is for illustrative purposes only. FIG. 2 is not intended to define a strict division between different parts of hardware on a chip or between different programs, procedures or functions in software. In some embodiments, some or all of the algorithms described herein may be performed wholly or partly in hardware. In other implementations, the algorithms may be implemented by a processor acting under software control. Any such software is preferably stored on a non-transient computer readable medium, such as a memory (RAM, cache, hard disk etc.) or other storage means (USB stick, CD, disk etc.).

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

What is claimed is:

1. A wireless communications device capable of operating according to a WLAN communications protocol, and capable of communicating in a mesh network, the wireless communications device being configured to:
generate a mesh network data packet;
encapsulate the mesh network data packet in a WLAN data frame, wherein the WLAN data frame is constructed such that it is capable of being received and accurately decoded by WLAN-capable devices with which the wireless communications device has not established a WLAN communications connection; and
transmit the WLAN data frame.

2. A wireless communications device according to claim 1, wherein the WLAN data frame is a WLAN beacon frame.

3. A wireless communications device according to claim 1, wherein the wireless communications device is capable of operating according to a second wireless communications protocol different to the WLAN communications protocol, and the wireless communications device is further configured to:
receive a prior mesh network data packet according to the second wireless communications protocol, the prior mesh network data packet comprising a payload; and
generate the mesh network data packet such that the payload of the mesh network data packet comprises the payload of the prior mesh network data packet.

4. A wireless communications device according to claim 3, wherein the second wireless communications protocol is a Bluetooth Low Energy protocol.

5. A wireless communications device according to claim 3, wherein the prior mesh network data packet comprises a first lifetime value, and wherein the wireless communications device is further configured to only generate the mesh network data packet such that the payload of the mesh network data packet comprises the payload of the prior mesh network data packet if the first lifetime value is indicative that the payload of the prior mesh network data packet is to be relayed to other devices.

6. A wireless communications device according to claim 5, wherein the mesh network data packet comprises a second lifetime value, and wherein the wireless communications device is further configured to select the second lifetime value so as to indicate that the payload of the prior mesh network data packet has been received and relayed.

7. A wireless communications device according to claim 3, further configured to:
perform a comparison of a portion of the prior mesh network data packet and a record of mesh network data packets previously received by the wireless communications device; and
only generate the mesh network data packet such that the payload of the mesh network data packet comprises the payload of the prior mesh network data packet if the comparison indicates that the prior mesh network data packet has not been previously received by the wireless communications device.

8. A wireless communications device capable of operating according to both a first wireless communications protocol and a second wireless communications protocol, and capable of communicating in a mesh network, the wireless communications device being configured to:
receive a prior mesh network data packet according to the second wireless communications protocol, the prior mesh network data packet comprising a payload;
generate a mesh network data packet such that the payload of the mesh network data packet comprises the payload of the prior mesh network data packet;
encapsulate the mesh network data packet in a data frame according to the first wireless communications protocol; and
transmit the data frame.

9. A wireless communications device as claimed in claim 8, wherein the first wireless communications protocol is a WLAN protocol.

10. A wireless communications device as claimed in claim 9, further configured to construct the data frame such that it is capable of being received and accurately decoded by WLAN-capable devices with which the wireless communications device has not established a WLAN communications connection.

11. A wireless communications device as claimed in claim 10, wherein the data frame is a WLAN beacon frame.

12. A wireless communications device as claimed in claim 8, wherein the second wireless communications protocol is a Bluetooth Low Energy protocol.

13. A wireless communications device as claimed in claim 8, further configured to construct the data frame such that it is capable of being received and accurately decoded by devices capable of operating according to the first wireless communications protocol with which the wireless communications device has not established a communications connection according to the first wireless communications protocol.

14. A wireless communications device according to claim 8, wherein the prior mesh network data packet comprises a first lifetime value, and wherein the wireless communications device is further configured to only generate the mesh network data packet such that the payload of the mesh network data packet comprises the payload of the prior mesh network data packet if the first lifetime value is indicative that the payload of the mesh network data packet is to be relayed to other devices.

15. A wireless communications device according to claim 14, wherein the mesh network data packet comprises a second lifetime value, and wherein the wireless communications device is further configured to select the second lifetime value so as to indicate that the payload of the prior mesh network data packet has been received and relayed.

16. A wireless communications device according to claim 8, further configured to:
perform a comparison of a portion of the prior mesh network data packet and a record of mesh network data packets previously received by the wireless communications device; and
only generate the mesh network data packet such that the payload of the mesh network data packet comprises the payload of the prior mesh network data packet if the comparison indicates that the prior mesh network data packet has not been previously received by the wireless communications device.

17. A wireless communications device capable of operating according to a WLAN communications protocol, and capable of communicating in a mesh network, the wireless communications device being configured to:
receive a WLAN data frame from a WLAN-capable device with which the wireless communications device has not established a WLAN communications connection;
extract from the WLAN data frame a mesh network data packet, the mesh network data packet having been encapsulated in the WLAN data frame; and
accurately decode the mesh network data packet.

18. A wireless communications device according to claim 17, wherein the WLAN data frame is a WLAN beacon frame.

19. A wireless communications device according to claim 17, wherein the mesh network data packet comprises a payload and a first lifetime value, and wherein the wireless communications device is further configured to:
generate a further mesh network data packet such that the payload of the further mesh network data packet comprises the payload of the mesh network data packet only if the first lifetime value is indicative that the payload is to be relayed to other devices; and
transmit the mesh network data packet.

20. A wireless communications device according to claim 19, wherein the further mesh network data packet comprises a second lifetime value, and wherein the wireless communications device is further configured to select the second lifetime value so as to indicate that the payload of the mesh network data packet has been received and relayed.
